(19) United States
(12) Patent Application Publication
(10) Pub. No.: US 2023/0087978 A1
(43) Pub. Date: Mar. 23, 2023

(54) AQUEOUS ION EXCHANGE STRENGTHENING OF GLASS ARTICLES

(71) Applicant: Owens-Brockway Glass Container Inc., Perrusburg, OH (US)

(72) Inventors: Matthew Vishy, Hunnewell, MO (US); Dan Swiler, Maumee, OH (US); Cody Hickerson, Perrysburg, OH (US); Rachel Breitner, Perrysburg, OH (US); John Rich, Maumee, OH (US)

(21) Appl. No.: 17/947,121

(22) Filed: Sep. 17, 2022

Related U.S. Application Data
(60) Provisional application No. 63/245,761, filed on Sep. 17, 2021.

(51) Int. Cl. C03C 21/00; C03C 23/00

(52) U.S. Cl. CPC C03C 21/002; C03C 23/007

(57) ABSTRACT

An aqueous ion exchange strengthening method for strengthening a glass container is disclosed that includes a step of exposing a surface of a glass container to an aqueous ion exchange solution that comprises water and an alkali metal salt to coat the surface of the glass container with a coating of the aqueous ion exchange solution. The alkali metal of the alkali metal salt may be potassium, rubidium, caesium, or mixtures thereof. The aqueous ion exchange strengthening process also includes the step of heat treating the glass container in a heated environment having a temperature ranging from 125° C. to 600° C.

### TECHNICAL FIELD

This disclosure relates to the strengthening of glass and, more particularly, to strengthening glass containers through an ion-exchange treatment.

### BACKGROUND

Various ion-exchange processes have been developed to modify glass surfaces. For example, U.S. Pat. No. 3,844,754 discloses a process for strengthening a glass article by forming a solid layer of an alkali metal salt on a surface of the glass, and then heating the glass article and the solid layer at an elevated temperature to carry out an exchange of ions. The alkali metal salt must contain an alkali metal carbonate, and the glass article may be heated to a suitably elevated temperature by passing the glass article through an annealing lehr. In another example, U.S. Pat. No. 9,045,364 discloses that surface treating a glass container using a heated aqueous electrolyte solution comprising salts of at least one group IA alkali metal can result in an ion exchange at the surface of the container to reduce light reflection from the container without reducing light transmission through the container or the clarity of the glass container.

### SUMMARY OF THE DISCLOSURE

In accordance with one aspect of the disclosure, there is provided an aqueous ion exchange strengthening method for strengthening a glass container. The method comprises exposing a surface of a glass container to an aqueous ion exchange solution that comprises water and an alkali metal salt to coat the surface of the glass container with a coating of the aqueous ion exchange solution, and heat treating the surface of the glass container at a temperature ranging from 125° C. to 600° C. The alkali metal of the alkali metal salt included in the aqueous ion exchange solution is selected from the group consisting of potassium, rubidium, caesium, and mixtures thereof

In another embodiment, an aqueous ion exchange strengthening method for strengthening a glass container comprises exposing a surface of a glass container to an aqueous ion exchange solution having a temperature ranging from 60° C. to 120° C. to coat the surface of the glass container with a coating of the aqueous ion exchange solution, heat treating the glass container in a heated environment having a temperature ranging from 150° C. to 500° C., and removing the glass from the heated environment. The aqueous ion exchange solution comprises water and an alkali metal salt selected from the group consisting of potassium nitrate, potassium chloride, and mixtures thereof.

In yet another embodiment, an aqueous ion exchange strengthening method for strengthening a glass container comprises exposing a surface of a glass container to a caustic solution, spraying an aqueous ion exchange solution having a temperature ranging from 75° C. to 100° C. onto the surface of the glass container to coat the surface of the glass container with a coating of the aqueous ion exchange solution, and heat treating the surface of the glass container in a heated environment having a temperature ranging from 150° C. to 500° C. The aqueous ion exchange solution that is sprayed onto the surface of the glass container comprises deionized water and an alkali metal salt selected from the group consisting of potassium chloride, potassium nitrate, and mixtures thereof.

### BRIEF DESCRIPTION OF THE DRAWINGS

FIG. 1 illustrates Weibull plots of cumulative failure probability (%) vs. failure strength (MPa) for soda-lime-silica glass slides treated by an AIE strengthening process according to the present disclosure (AIE Process), for soda-lime-silica glass slides treated by another process not according to the present disclosure (Other Process), and for baseline untreated soda-lime-silica glass slides;

FIG. 2 illustrates Weibull plots of cumulative failure probability (%) vs. failure strength (MPa) for soda-lime-silica glass slides treated by an AIE strengthening process according to the present disclosure at different heat treatment temperatures (350° C. to 550° C. at 4 hours);

FIG. 3 illustrates Weibull plots of cumulative failure probability (%) vs. failure strength (MPa) for soda-lime-silica glass slides treated by an AIE strengthening process according to the present disclosure at different heat treatment times (30 minutes to 4 hours at 450° C.);

FIG. 4 illustrates Weibull plots of cumulative failure probability (%) vs. failure strength (MPa) for soda-lime-silica glass slides treated by an AIE strengthening process according to the present disclosure with aqueous ion exchange solutions that were aged differently (new, old, modified new);

FIG. 5 illustrates Weibull plots of cumulative failure probability (%) vs. failure strength (MPa) for soda-lime-silica glass slides treated by an AIE strengthening process according to the present disclosure in which the aqueous ion exchange solution included KNO₃ as the dissolved potassium salt, for soda-lime-silica glass slides treated by an AIE strengthening process according to the present disclosure in which the aqueous ion exchange solution included KNO₃ and KCl at a mass ratio of KNO₃:KCl of 2:1 as the dissolved potassium salts, and for untreated untreated soda-lime-silica glass slides;

FIG. 6 (previously none) illustrates Weibull plots of cumulative failure probability (%) vs. failure strength (MPa) for soda-lime-silica glass slides treated by an AIE strengthening process according to the present disclosure with a caustic soak prior to application of the aqueous ion exchange solution, for soda-lime-silica glass slides treated by an AIE strengthening process according to the present disclosure without a caustic soak, for soda-lime-silica glass slides soaked in a caustic solution only and thereafter not treated by an AIE strengthening process according to the present disclosure, and for baseline untreated soda-lime-silica glass slides;

FIG. 7 (previously none) illustrates Weibull plots of cumulative failure probability (%) vs. burst strength (psi) for glass containers treated by an AIE strengthening process according to the present disclosure at different heat treatment temperatures (400° C. to 500° C. at 1 hour);

FIG. 8 (previously none) illustrates Weibull plots of cumulative failure probability (%) vs. burst strength (psi) for glass containers treated by an AIE strengthening process according to the present disclosure at different heat treatment times (30 minutes to 2 hours at 500° C.); and

FIG. 9 (previously none) illustrates Weibull plots of cumulative failure probability (%) vs. burst strength (psi) for glass containers treated by an AIE strengthening process according to the present disclosure in which the aqueous ion exchange solution included KNO₃ and KCl at a mass ratio of KNO₃:KCl of 1:5 as the dissolved potassium salts, for glass containers treated by an AIE strengthening process according to the present disclosure in which the aqueous ion exchange solution included KNO₃ and KCl at a mass ratio of KNO₃:KCl of 2:1 as the dissolved potassium salts, for glass containers treated by an AIE strengthening process according to the present disclosure in which the aqueous ion exchange solution included only KCl as the dissolved potassium salt, and for baseline untreated soda-lime-silica glass slides.

### DETAILED DESCRIPTION

Past uses of ion exchange to treat the surface of a glass container required long exposure times of the glass to the ion exchange solution, typically on the order of 12 hours or more at temperatures of at least 75° C. up to 400° C. These long processing times complicated the ion-exchange procedures and made them difficult to implement. The presently disclosed aqueous ion exchange strengthening process exposes the glass container to the ion exchange solution, preferably through a spray application, for a much shorter exposure time followed by a heat treatment step in which the container is heated in a heated environment that is maintained at a temperature below the glass transition temperature of the glass. This process strengthens the glass and while avoiding demands for long processing times. Moreover, as part of the aqueous ion exchange strengthening process, the glass container may be exposed to a caustic solution prior to or while exposing the container to the aqueous ion exchange solution, which may improve the ion exchange mechanism and, thus, help further improve container strength.

In the present ion-exchange process, sodium ions in and on the surface of the glass container are exchanged for ions having a larger radius to introduce a compressive stress layer into the glass, thereby reducing crack lengthening and strengthening the glass. This is accomplished by exposing the glass to an aqueous ion exchange solution comprising potassium ions, preferably in the form of potassium nitrate (KNO₃) and/or potassium chloride (KCl), and water, although other sources of potassium ions could be substituted for the nitrate and chloride salts including sulfates or carbonates. For spray applications of the aqueous ion exchange solution, the solution preferably includes only water and the potassium salt(s), plus an optional hydroxide-containing salt such as NaOH to raise the pH of the solution, if desired, along with commercially acceptable impurities that may be present in the water and the salt(s). The water used for spraying is also preferably deionized (DI) water. It is believed that other alkali metal ions—in the form of nitrates, chlorides, sulfates, and/or carbonates—having a larger atomic radius than sodium ions could also be used in place of potassium. These other alkali metal ions include Rubidium (Rb), Caesium (Cs), and/or Francium (Fr).

When potassium ions are included in the aqueous ion exchange solution as the larger atomic-radii alkali metal ions, the solution may comprise from 0.3 to 6.0 molar KNO₃ and from 0.5 to 6.0 molar KCl, or more narrowly from 0.7 to 2.9 molar KNO₃ and from 1.9 to 4.8 molar KCl. The mass fractions for each of KNO₃ and KCl in solution may range from 0% to 45%, or more narrowly from 1% to 30%, based on the total mass of the aqueous ion exchange solution, with a total mass fraction of the KNO₃ plus KCl ranging from 5% to 45% or, more narrowly, from 10% to 30%. Additionally, the mass ratio of KNO₃ to KCl (KNO₃:KCl ) in the aqueous ion exchange solution preferably ranges from 2:1 to 1:8 or, more narrowly, from 1:4 to 1:6. These mass ratio ranges are believed to support better initial retention of the aqueous ion solution onto the surface of a glass container because, as can be seen from the phase diagram of KCl/KNO₃, a more KCl rich solution provides a greater proportion of the salt in the solid phase.

In addition, the aqueous ion exchange solution may have a pH of 6.0 to 10.0 or, more narrowly, a pH of 8.5 to 9.5, which may be accomplished by introducing OH⁻ anions into the aqueous ion solution. For example, a total amount to the OH⁻ anions may be included in the solution by the addition of amount up to 10 mol % or, more narrowly, up to 5 mol % or up to 2 mol %, of a hydroxide-containing salt such as NaOH. The elevated pH of the aqueous ion exchange solution, especially if achieved through the addition of OH⁻ anions, is believed to help improve the wettability of the aqueous ion exchange solution and potentially exposes more of the surface flaws in the glass surface to the ion exchange solution. As will be described in more detail below, exposure of the glass container to the aqueous ion exchange solution and the caustic solution is considered to occur at the same time when OH⁻ anions are added into the aqueous ion exchange solution to raise the pH of the solution to 8.0 or above.

The present aqueous ion exchange strengthening process may be used to strengthen a glass container composed of inorganic silica-based glasses—most notably soda-lime-silica glass. A preferred soda-lime-silica glass may have the composition shown in Table 1. Other silica-based glasses such as borosilicate glass and aluminosilicate glass may also benefit from the disclosed aqueous ion exchange strengthening process. A preferred borosilicate glass may have the composition shown in Table 2 below and a preferred aluminosilicate glass may have the composition shown in Table 3 below.

TABLE 1
Soda-Lime-Silica Glass

| Component | Weight % |
|---|---|
| SiO₂ | 60-75 |
| Na₂O | 7-15 |
| CaO | 6-12 |
| Al₂O₃ | 0.1-5 |
| MgO | 0-2 |
| K₂O | 0-2 |

TABLE 2
Borosilicate Glass

| Component | Weight % |
|---|---|
| SiO₂ | 70-85 |
| B₂O₃ | 8-15 |
| Na₂O | 3-5 |
| Al₂O₃ | 2-5 |
| K₂O | 0-1 |

TABLE 3
Aluminosilicate Glass

| Component | Weight % |
|---|---|
| SiO₂ | 50-65 |
| Al₂O₃ | 20-40 |
| MgO | 7-12 |
| CaO | 5-10 |
| B₂O₃ | 3-4 |
| Na₂O | 0-1 |

The glass container also may include other materials in relatively small amounts. For example, the glass may include small amounts of TiO₂, Fe₂O₃, FeO, MnO₂, SO₃, Se, colorants, decolorants, redox agents, and other minor materials. Each of these other materials may be additives and/or impurities in the raw materials used to produce the glass and may be present in the glass container in amounts of 1% or less by weight based on the total weight of the glass.

The glass container may be produced by any suitable method. For example, the glass container may be produced in a continuously operated glass manufacturing facility, which typically includes a glass furnace having an upstream end where raw materials are introduced, and a downstream end from which molten glass is distributed. Exemplary conditions and procedures for composing and melting container glass can be found in, for example, The Handbook of Glass Manufacture by Fay V. Tooley (3rd ed., Ashlee Publishing 1984). Other processes for melting and forming glass into a glass container may also be employed since, in general, the manner in which the glass container is produced is not critical to the ion exchange treatment disclosed herein.

In a conventional container glass manufacturing facility, molten glass is channeled from the glass furnace through a forehearth to a container forming machine as a weighed “gob” of molten glass. The glass gob is loaded into the forming machine, known as individual section, where it is molded to the desired container design. Thereafter, the glass container is passed through an annealing lehr where the container is reheated and slowly cooled according to a predetermined temperature profile to remove thermally induced strain. The upstream portions of a container glass manufacturing process (e.g., the glass melting, forming, and annealing processes) are typically referred to as “hot-end” processes, while the downstream portions (e.g., the glass container inspection, labeling, and packaging processes) are typically referred to as “cold-end” processes. Conventionally, a “hot-end coating” of tin oxide (SnO₂) or titanium dioxide (TiO₂) is applied to newly formed glass containers before they are passed through the annealing lehr. A hot-end coating is applied to protect the exterior surface of the glass container from damage and to prepare the container for the subsequent application of one or more “cold-end coatings,” which are typically applied to the glass container after the container exits the annealing lehr. The cold-end coating is usually a wax, such as polyethylene was, and is applied to protect the exterior surface of the glass container from damage and to decrease friction while the container is transported.

According to the present disclosure, the exterior surface of the container, the interior surface of the container, or both surfaces of the glass container are treated by the aqueous ion exchange strengthening process after annealing either before or after the glass container is coated with a cold-end coating. The aqueous ion exchange strengthening process introduces a compressive stress layer onto the treated surface(s) of the glass container and includes (i) an aqueous ion exchange (AIE) solution exposure step; (ii) a heat treatment step; and (iii) an optional caustic solution exposure step prior to or during the AIE solution exposure step. In the AIE solution exposure step, at least a portion of a surface of the glass container—which may include some or all of the exterior surface of the container, the interior surface of the container, or both surfaces—is exposed to the AIE solution described above to apply an AIE coating to the container through which exchangeable ions in the glass container are exchanged with, or replaced by, the alkali metal ions in the solution. The exchanged ions are preferably potassium cations as previously explained.

The exposure of the glass container to the AIE solution may be accomplished in a variety of ways. In a preferred implementation, the AIE solution is sprayed onto the surface(s) of the glass container through a spray nozzle. Spraying is good candidate for solution application because the chemical integrity of the solution can be maintained over time and the desired film thickness and uniformity can be tailored and/or controlled. And, to aid in the spraying application, as previously mentioned, the AIE solution preferably includes only DI water, the dissolved potassium salt(s), and if desired the optional hydroxide-containing salt. Other methods of applying the aqueous ion exchange solution may also be utilized in the presently disclosed strengthening process including, for example, dip coating and immersion.

The AIE solution is applied to the glass container at a temperature ranging from 60° C. to 120° C. or, more narrowly, 75° C. to 100° C. to apply the AIE coating. The applied AIE solution is left on the glass container surface(s) for an exposure time of 2 seconds to 100 minutes or longer, but in many instances the exposure time may range from 2 minutes to 60 minutes. Multiple exposures to the AIE solution with intermittent drying of, for example, 30 seconds to 60 seconds between the AIE exposures may also be practiced, if desired. In some embodiments, a mask may be used to selectively limit exposure of the container to the AIE solution.

After the AIE solution exposure step, the glass container may be dried in air at room temperature (i.e., 20° C. to 26° C.) and/or in a heated environment above room temperature, or the glass container may simply be transitioned directly to the heat treatment step. The heat treatment step involves heating the glass container, which now has an applied AIE coating, in a heated environment, such as a furnace, lehr, or oven, for example, that is maintained at a temperature ranging from 125° C. to 600° C. or, more narrowly, from 150° C. to 500° C. In a preferred embodiment for soda-lime-silica glass, the temperature of the heated environment ranges from 150° C. to 470° C. so that the glass does not become too relaxed during the heat treatment step. The glass container may be kept in the heated environment for a period of time ranging from 20 minutes to 24 hours, although typically a period of 30 minutes to 4 hours will suffice. After the heating period, the glass container is removed from the heated environment and any residual salts from the AIE solution is rinsed off with water, and any residual water is blown off the glass container with compressed air.

The treated glass container that results from the AIE solution exposure step and the heat treatment step is significantly stronger than an untreated glass container and the process time is shorter in duration than previous ion exchange processes that generally call for a 12 hour to 24 hour of exposure time to the ion exchange solution. Although not wishing to be bound by theory, one explanation for the increased strength may be that the larger radius of the K⁺ ions, compared to the Na⁺ ions, forms the compressive stress layer in the glass where the Na⁺ has been replaced by the K⁺, and this compressive stress layer achieves more consistent application and improved ion exchange through a combination of the formulation of the aqueous ion exchange solution and the heat treatment step. The resultant compressive stress layer must be overcome for cracks to propagate, thereby effectively strengthening the glass container.

The aqueous ion exchange strengthening process may be practiced with the optional caustic solution exposure step, which may be practiced prior to or at the same time as the AIE solution exposure step. In the caustic solution exposure step, the glass container is exposed to a caustic solution by any suitable approach including, for example, soaking the container in a caustic solution bath before exposing the glass container to the AIE solution in the AIE solution exposure step. The caustic solution to which the glass container is exposed has a pH of between 8 and 10, or more narrowly between 8.8 and 9.6, and includes at least 2 mol % and, more preferably, between 2 mol % and 10 mol % of the hydroxide-containing salt, dissolved in DI water. The glass container may be exposed to the caustic solution via soaking or otherwise for a period of time ranging from 15 seconds to 10 minutes or, more narrowly, from 1 minute to 6 minutes. By exposing the glass container to the caustic solution before the AIE solution exposure step, the strength of the container due to the resultant formation of the compressive stress layer is enhanced. The mechanism for this boost in strength is believed to be related to the brief dissolution of glass in the solution, which may enable the compressive stress layer to better occupy existing cracks or other glass defects.

In another example of the caustic solution exposure step, the glass container may be exposed to the caustic solution during (i.e., at the same time as) exposure to the AIE solution. These two exposure steps can be carried out simultaneously by additionally adding the hydroxide-containing salt, such as NaOH, to the AIE solution along with the potassium salt(s) to introduce enough OH⁻ anions into the AIE solution that the pH of the solution is raised to 8.0 or above, including to the preferred range mentioned above of 8.8 to 9.6. Under these circumstances, the higher pH AIE solution basically serves as both the AIE solution and the caustic solution at the same time such that the glass container is deemed to be exposed to the AIE solution and the caustic solution simultaneously, thus allowing for the AIE solution exposure step and the caustic solution exposure step to be performed together. Whether the caustic solution exposure step is carried out before or during the AIE solution exposure step, the resultant boost in the strength of the container due to enhancement of the compressive stress layer is thought to be generally the same.

### EXAMPLES

### Example 1

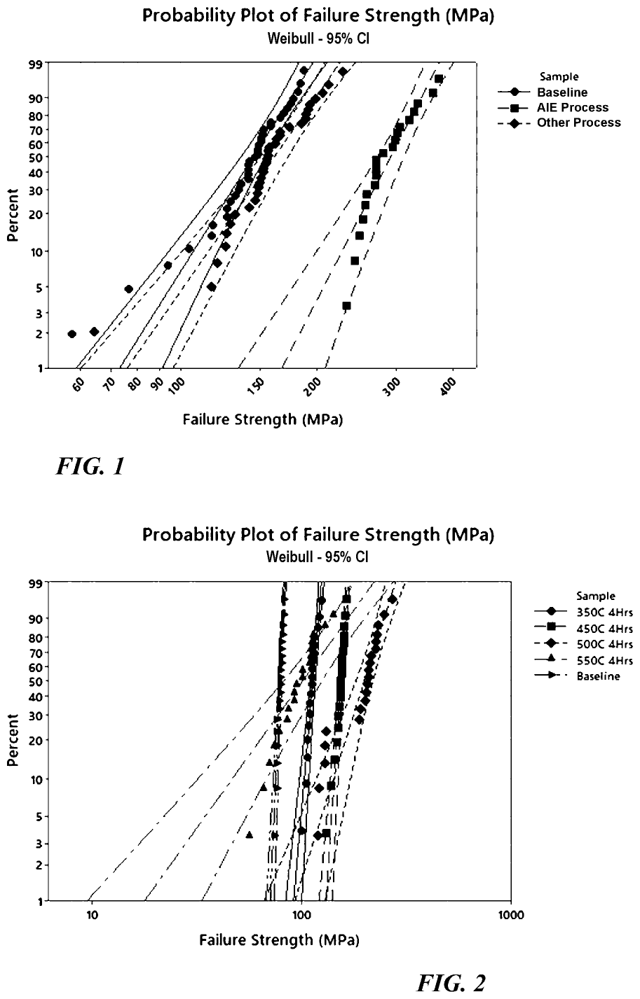

In a first example of the present aqueous ion exchange strengthening process (“AIE Process” in FIG. 1), an aqueous ion exchange solution was prepared by dissolving 200 grams of KNO₃ and 100 grams of KCl in 700 milliliters of DI water. This produced a solution of 2.82 molar KNO₃ and 1.91 molar KCl with an alkali metal salts mass percentage of 30%. The solution was heated to and maintained at a temperature of 75° C. Soda-lime-silica glass slides were exposed by dipping to the solution for 30 minutes, removed and allowed to air dry for 30 to 60 seconds, and then exposed to the solution again by dipping for another 30 minutes, removed, and allowed to air dry. The final air dried samples were then moved to an oven maintained at a temperature of 350° C. and heat treated for 4 hours. After 4 hours of heat treatment, the samples were removed and allowed to cool for 30 minutes. The samples were then rinsed for 10 to 20 seconds with DI water to remove any residual salts and blown dry with compressed air.

A second set of soda-lime-silica glass slides was treated according to a process in which the slides were exposed to the same aqueous ion exchange solution at 75° C. for 24 hours, removed from the solution, rinsed with DI water for 10 to 20 seconds to remove any residual salts, and blown dry with compressed air (“Other Process” in FIG. 1). A third set of untreated soda-lime-silica slides glass was used as a control set of slides; these slides were not exposed to any ion exchange solutions nor heat treated (“Baseline” in FIG. 1).

The three sets of soda-lime-silica glass slides were tested for failure strength using a ring on ring (ROR) compression test as is known in the art. The slides were taped with polytetrafluoroethylene (PTFE) tape prior to testing so that a failure analysis could be performed after the test. The displacement rate of the failure strength breaking fixture was 0.24 millimeters/minute and coated side of the slide was in tension during the test. The samples were loaded until they broke and the maximal load reached prior to failure was recorded as the failure strength. The average failure strength of the AIE Process slides, the Other Process slides, and the Baseline slides are shown in FIG. 1 with the data fit to a Weibull Distribution. The data shows that there was a noticeable shift to the right of the line for the slides treated according to the AIE Process, which indicates an increase in failure strength. The average failure strength of the Baseline slides was 57.4 megapascals (MPa), similar to the Other Process slides (average failure strength of 64.3 MPa, while the average failure strength of the slides treated according to the AIE Process was 233 MPa—a four-fold increase in failure strength. Additionally, the failure strength breaking force for the Other Process ranged from 1100 to 3700 Newtons whereas the failure strength breaking force for the slides treated according to the AIE Process ranged from 3700 to 6000 Newtons.

### Example 2

In a second series of experiments, the same AIE solution described in Example 1 for the AIE Process (i.e., 200 grams of KNO₃ and 100 grams of KCl dissolved in 700 milliliters of DI water) was prepared, and indented soda-lime-silica glass slides were exposed to the solution by dipping. The indented slides were uniformly damaged using a Vickers Indenter applying 300 grams force (gf), and where then exposed to the AIE solution, which was maintained at 75° C. for 2 minutes. After exposure to the AIE solution, the slides where heat treated at various temperatures (350° C., 450° C., 500° C., and 550° C.) for 4 hours. In addition, for comparison, a baseline series of untreated soda-lime-silica glass slides was included in the experiments. The glass slides were subjected to ROR fracture testing and the data was fit to Weibull Distribution plots, which are shown in FIG. 2. The plotted data shows that the failure strength of the samples increased generally with temperature up to 500° C., but seemed to start decreasing at 550° C., which is believed to be the result of ion exchange mechanism being performed above the strain point of the glass.

### Example 3

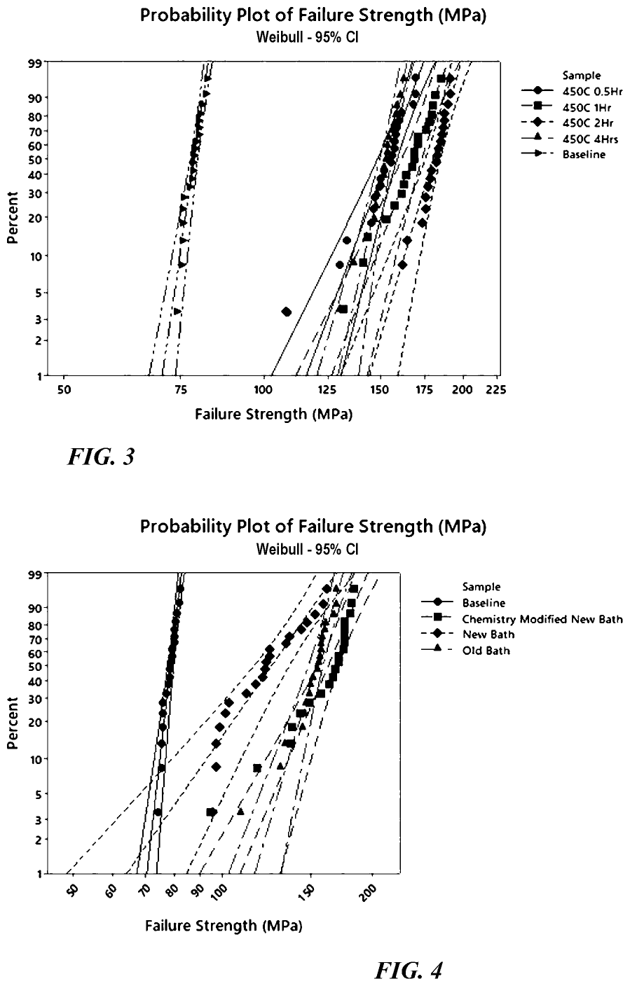

In a third series of experiments, the same AIE solution described in Example 1 for the AIE Process (i.e., 200 grams of KNO₃ and 100 grams of KCl dissolved in 700 milliliters of DI water) was prepared, and indented soda-lime-silica glass slides were exposed to the solution by dipping. The soda-lime-silica glass slides were exposed to the AIE solution, which was maintained at 75° C., by dipping for 2 minutes, and then subjected to heat treatment at 450° C. at various times of 30 minutes, 1 hour, 2 hours, and 4 hours. In addition, for comparison, a baseline series of untreated soda-lime-silica glass slides was included in the experiments. The glass slides were subjected to ROR fracture testing and the data was fit to Weibull Distribution plots, which are shown in FIG. 3. The plotted data shows that the failure strength of the samples did not necessarily increase with an increasing heat treatment time, which is believed to be the result of the AIE coating on the container becoming saturated with sodium ions from the glass over time.

### Example 4

In a fourth series of experiments, the enhancement of failure strength as influenced by the AIE solution, particularly the pH of the solution, was examined. In these experiments, a “new” AIE solution was prepared as 200 grams of KNO₃ and 100 grams of KCl dissolved in 700 milliliters of DI water, as in the other Examples. Also, a “chemistry modified” AIE solution was prepared by first preparing a new solution, as described above, and then soaking 40 soda-lime-silica glass slides in the new solution for two weeks. An “old” AIE solution was simply an AIE solution that had been in use for six months with intermittent use. Each of the old and the chemically modified AIE solutions had a higher pH (pH>8) than the new bath (pH<8).

Indented soda-lime-silica glass slides were exposed by dipping to each of the “new,” “chemistry modified,” and “old” AIE solutions. The slides were placed into the designated AIE solution, which was maintained at 75° C., for 2 minutes, and then removed and placed into an oven maintained at 450° C. for 30 minutes to heat treat the slides. The slides were removed from the oven and rinsed for 10 to 20 seconds with DI water. In addition, for comparison, a baseline series of untreated soda-lime-silica glass slides was included in the experiments. The glass slides were subjected to ROR fracture testing and the data was fit to Weibull Distribution plots, which are shown in FIG. 4. As can be seen, the raised pH of the “chemistry modified” and the “old” solutions contributed to improved failure strength in the glass, as is observed by the shift in the lines associated with the “chemistry modified” and “new” AIE solutions to the right of the line associated with the “new” AIE solution.

### Example 5

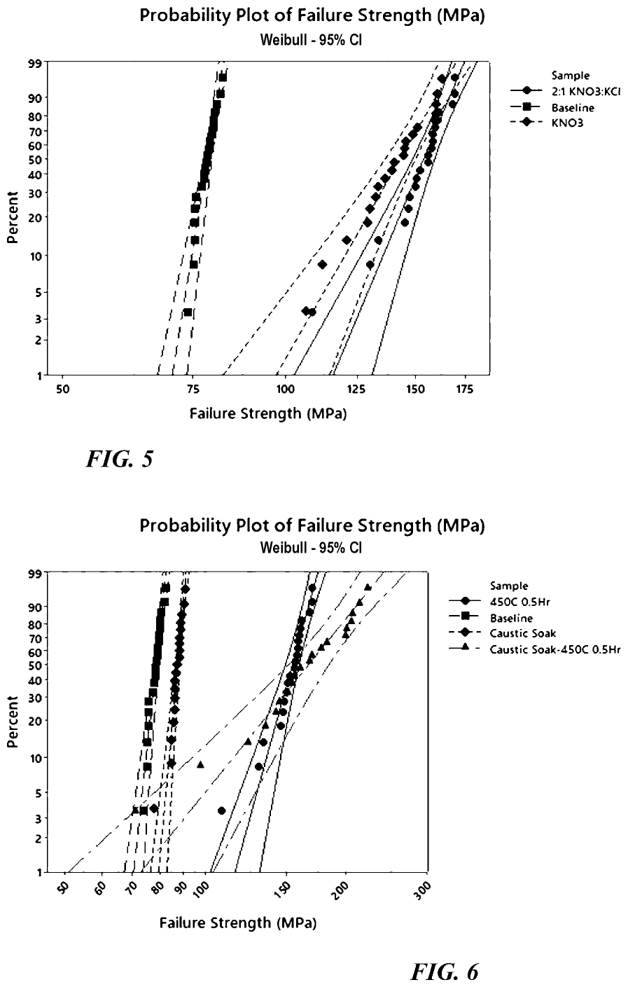

In a fifth series of experiments, two AIE solutions where prepared: (1) one solution as described in Example 1 for the AIE Process (i.e., 200 grams of KNO₃ and 100 grams of KCl dissolved in 700 milliliters of DI water) and (2) another solution that included 335 grams of KNO₃ dissolved in 700 milliliters of DI water. Indented soda-lime-silica glass slides were exposed to the two solutions, which were maintained at 75° C., by dipping for 2 minutes, followed by heat treating the slides in an oven at 450° C. for 30 minutes. In addition, for comparison, a baseline series of untreated soda-lime-silica glass slides was included in the experiments. The glass slides were subjected to ROR fracture testing and the data was fit to Weibull Distribution plots, which are shown in FIG. 5. The data shows that gains in failure strength were seen when the AIE solution contains both the nitrate and chloride salts of potassium, although the use of only one of the potassium salts still showed improved failure strength compared to the baseline glass.

### Example 6

In a sixth series of experiments, the same AIE solution described in Example 1 for the AIE Process (i.e., 200 grams of KNO₃ and 100 grams of KCl dissolved in 700 milliliters of DI water) was prepared. Additionally, a caustic solution was prepared that contained 5 mol % NaOH in DI water. Indented soda-lime-silica glass slides were exposed to the AIE solution by dipping or were soaked in the caustic solution first for 20 minutes at room temperature followed by exposure to the AIE solution by dipping. In each case, the AIE solution was maintained at 75° C. and the slides were dipped in the solution for 2 minutes. Furthermore, after exposure to the AIE solution, the glass slides were heat treated in an oven at 450° C. for 30 minutes. A baseline series of untreated soda-lime-silica glass slides was also included in the experiments for comparison. The glass slides were subjected to ROR fracture testing and the data was fit to Weibull Distribution plots, which are shown in FIG. 6. An improvement in failure strength was seen with the caustic soak. The reason for this strength improvement may be due to the caustic solution attacking the indentation cracks on the glass slides, which, in turn, may open up the flaws and allow the AIE solution to penetrate deeper into the cracks and ion exchange more directly with the crack tips.

### Example 7

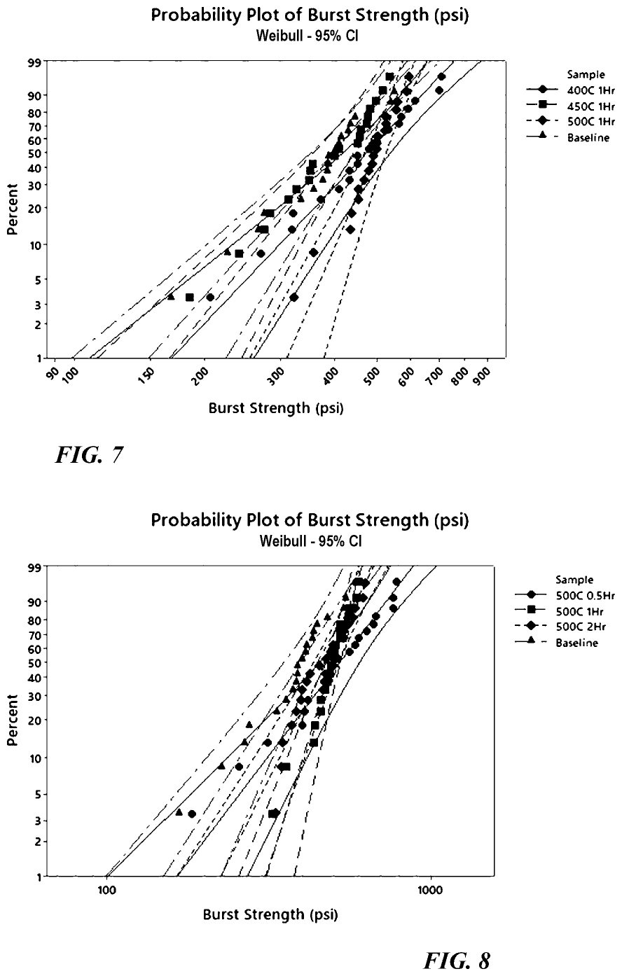

In a seventh series of experiments, an aqueous ion exchange solution was prepared by dissolving 240 grams of KNO₃ and 120 grams of KCl in 500 milliliters of DI water. This produced a solution of 4.74 Molar KNO₃ and 3.22 Molar KCl with an alkali metal salts mass percentage of 42%. Soda-lime-silica glass bottles (220 grams in weight) were exposed to the AIE solution, which was maintained at 75° C., by dipping for 1 minute. After exposure to the AIE solution, the glass bottles were placed in an oven and heat treated at various temperatures (350° C., 450° C., 500° C., and 550° C.) for 1 hour. A baseline series of untreated soda-lime-silica glass bottles was also included in the experiments for comparison. The glass bottles were taped with packing tape and pressure tested as is known in the art using a glass bottle burst tester. The burst strength results were recorded and the data was fit to Weibull Distribution plots of cumulative failure probability (%) vs. burst strength (psi), which are shown in FIG. 7. As can be seen from FIG. 7, there is a general trend of increased burst strength for the treated glass containers versus the baseline glass containers.

### Example 8

In an eighth series of experiments, the same aqueous ion exchange solution described in Example 7 (i.e., 240 grams of KNO₃ and 120 grams of KCl dissolved in 500 milliliters of DI water) was prepared, and soda-lime-silica glass bottles were exposed to the solution by dipping. The soda-lime-silica glass bottles were exposed to the AIE solution, which was maintained at 75° C., by dipping for 1 minute, and then placed in an oven maintained at 500° C. for various times of 30 minutes, 1 hour, and 2 hours to heat treat the bottles. In addition, for comparison, a baseline series of untreated soda-lime-silica glass bottles was included in the experiments. The burst strengths of the bottles were determined the data was fit to Weibull Distribution plots, which are shown in FIG. 8. As can be seen from FIG. 8, there is a general trend of increased burst strength for the treated glass containers versus the baseline glass containers, and it appears that shorter heat treat times may be preferred when the heat treatment temperature is above the strain point of the glass, as it was in these experiments.

### Example 9

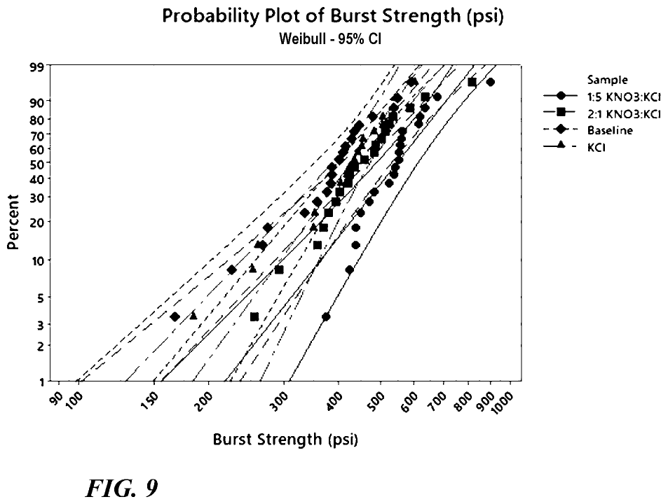

In a ninth set of experiments, three AIE solutions were prepared: (1) a KCl solution that included 250 grams of KCl dissolved in 700 milliliters of DI water; (2) a solution that included 240 grams of KNO₃ and 120 grams of KCl dissolved in 500 milliliters of DI water (2:1 KNO₃:KCl mass ratio); and (3) a solution that included 50 grams of KNO₃ and 250 grams of KCl dissolved in 700 milliliters of DI water (1:5 KNO₃:KCl mass ratio). All of the solutions were heated to 75° C. and glass bottles were exposed to each solution by dipping for 1 minute. The glass bottles were then place in an oven maintained at 450° C. for 30 minutes to heat treat the bottles. In addition, for comparison, a baseline series of untreated soda-lime-silica glass bottles was included in the experiments. The burst strengths of the bottles were determined and the data was fit to Weibull Distribution plots, which are shown in FIG. 9. The data shows that glass bottles exposed to the AIE solution having the KNO₃:KCl mass ratio of 1:5 achieved generally higher burst strengths than the bottles exposed to the AIE solution having the KNO₃:KCl mass ratio of 2:1, and that both AIE solutions that included a combination of nitrate and chloride potassium salts performed better than the AIE solution that included only KCl in terms of enhancing glass container burst strength.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation. All terms used herein are intended to be merely descriptive, rather than necessarily limiting, and are to be interpreted and construed in accordance with their ordinary and customary meaning in the art, unless used in a context that requires a different interpretation.

Finally, the subject matter of this application is presently disclosed in conjunction with several illustrative embodiments and modifications to those embodiments. Many other embodiments and modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. An aqueous ion exchange strengthening method for strengthening a glass container, the method comprising:
(a) exposing a surface of a glass container to an aqueous ion exchange solution that comprises water and an alkali metal salt to coat the surface of the glass container with a coating of the aqueous ion exchange solution, the alkali metal of the alkali metal salt being selected from the group consisting of potassium, rubidium, caesium, and mixtures thereof; and
(b) heat treating the surface of the glass container in a heated environment having a temperature ranging from 125° C. to 600° C.

2. The method set forth in claim 1, wherein a mass fraction of the alkali metal salt in the aqueous ion exchange solution ranges from 10 to 30% based on the total mass of the solution.

3. The method set forth in claim 1, wherein the aqueous ion exchange solution comprises at least one of KNO₃ or KCl.

4. The method set forth in claim 1, wherein the aqueous ion exchange solution consists of KNO₃, KCl, water, and optionally a hydroxide-containing salt.

5. The method set forth in claim 4, wherein exposing the surface of the glass container to the aqueous ion exchange solution comprises spraying the aqueous ion exchange solution onto the surface of the container.

6. The method set forth in claim 1, wherein the aqueous ion exchange solution has a pH of 8 or greater.

7. The method set forth in claim 1, further comprising exposing the surface of the glass container to a caustic solution prior to or during the step of exposing the surface of the glass container to the aqueous ion exchange solution.

8. The method set forth in claim 1, wherein step (a) comprises exposing the surface of the glass container to the aqueous ion exchange solution, which is at a temperature ranging from 60° C. to 120° C., for a period of time ranging from 2 seconds to 100 minutes.

9. The method set forth in claim 1, wherein step (b) comprises heat treating the glass container in a heated environment for a period of time ranging from 20 minutes to 24 hours.

10. An aqueous ion exchange strengthening method for strengthening a glass container, the method comprising:
(a) exposing a surface of a glass container to an aqueous ion exchange solution having a temperature ranging from 60° C. to 120° C. to coat the surface of the glass container with a coating of the aqueous ion exchange solution, the aqueous ion exchange solution comprising water and an alkali metal salt selected from the group consisting of potassium nitrate, potassium chloride, and mixtures thereof;
(b) heat treating the surface of the glass container in a heated environment having a temperature ranging from 150° C. to 500° C.; and
(c) removing the glass container from the heated environment.

11. The method set forth in claim 10, wherein the aqueous ion exchange solution comprises KNO₃ and KCl, and wherein a mass ratio of KNO₃ to KCl in the aqueous ion exchange solution ranges from 2:1 to 1:8.

12. The method set forth in claim 11, wherein the mass ratio of KNO₃ to KCl ranges from 1:4 to 1:6.

13. The method set forth in claim 10, wherein the aqueous ion exchange solution has a pH of 8 or greater.

14. The method set forth in claim 10, wherein step (a) comprises exposing the surface of the glass container to the aqueous ion exchange solution for a period of time ranging from 2 seconds to 100 minutes.

15. The method set forth in claim 10, wherein step (b) comprises heat treating the glass container in a heated environment for a period of time ranging from 30 minutes to 4 hours.

16. The method set forth in claim 10, further comprising exposing the surface of the glass container to a caustic solution prior to or during the step of exposing the surface of the glass container to the aqueous ion exchange solution.

17. The method set forth in claim 10, wherein the aqueous ion exchange solution consists of KNO₃, KCl, water, and optionally a hydroxide-containing salt, and wherein exposing the surface of the glass container to the aqueous ion exchange solution comprises spraying the aqueous ion exchange solution onto the surface of the container.

18. An aqueous ion exchange strengthening method for strengthening a glass container, the method comprising:
(a) exposing a surface of a glass container to a caustic solution;
(b) spraying an aqueous ion exchange solution having a temperature ranging from 75° C. to 100° C. onto the surface of the glass container to coat the surface of the glass container with a coating of the aqueous ion exchange solution, the aqueous ion exchange solution comprising deionized water and an alkali metal salt selected from the group consisting of potassium nitrate, potassium chloride, and mixtures thereof; and
(c) heat treating the surface of the glass container in a heated environment having a temperature ranging from 150° C. to 500° C.

19. The method set forth in claim 18, step (a) and step (b) are performed at the same time by further including a hydroxide-containing salt in the aqueous ion exchange solution to raise a pH of the aqueous ion exchange solution to 8.0 or above prior to spraying the surface of a glass container with the aqueous ion exchange solution.

20. The method set forth in claim 18, wherein the aqueous ion exchange solution comprises KNO₃ and KCl, and wherein a mass ratio of KNO₃ to KCl in the aqueous ion exchange solution ranges from 2:1 to 1:8.
